(19) United States
(12) Patent Application Publication
(10) Pub. No.: US 2011/0290161 A1
(43) Pub. Date: Dec. 1, 2011

(54) STAGE WITH MAGNETIC LOADING

(75) Inventor: Donald R. Faubion, Oakdale, CA (US)

(73) Assignee: VALLEY PRECISION, INC., Oakdale, CA (US)

(21) Appl. No.: 12/898,103

(22) Filed: Oct. 5, 2010

Related U.S. Application Data
(63) Continuation-in-part of application No. 12/789,035, filed on May 27, 2010.

(51) Int. Cl. F16M 13/00; B23P 19/00

(52) U.S. Cl. 108/137; 29/700

(57) ABSTRACT

A horizontal planar movable surface forms a stage used as a work holder for optics, scientific instruments, microscopes and the like. The stage has a fixed lower plate with parallel grooves for bearings and a central groove for a ferromagnetic strip. A movable upper plate has corresponding parallel grooves to receive the bearings and powerful magnets over the ferromagnetic strip to pull the upper plate towards the lower plate without surface contact. A magnetic shield is interposed between the magnets and the work support surface of the upper plate to block most magnetic flux from work tools carried by the stage.

### CROSS REFERENCE TO RELATED APPLICATION

This application is a continuation-in-part of prior application Ser. No. 12/789,035, filed May 27, 2010 by D. R. Faubion entitled “Stage Driver for Movable Stages”.

### TECHNICAL FIELD

The invention relates to construction of precision movable stages, i.e., horizontal planar surfaces used as work holders for optics or supports for scientific instruments, such as microscopes, lasers, wafer devices, profilometers and the like.

### BACKGROUND ART

Precision stages typically have an accurately positioned linearly movable stage supported on a fixed stage, sometimes using rails or rods or bearings or sometimes using non-contacting devices, such as air bearings. Often two linearly movable stages are supported on a fixed stage, with one movable stage moving in the x-direction and the other moving in the y-direction. The movable stages often have provisions for coarse and fine positioning in the x-y or horizontal plane using various control devices. For example, prior application Ser. No. 12/789,035 discloses a manually operated driver for moving stages with a hand-operated yoke allowing for rapid coarse position control and a screw for fine position control, described in further detail below.

In the prior art, such as in U.S. Pat. No. 6,193,199, it has been recognized that the vertical motion of stages due to vibration during horizontal motion is incompatible with the high degree of accuracy that can be achieved in the x-y plane, regardless of the method of translation of the stage. Therefore, efforts are made to eliminate or reduce the effects of vibration, particularly vertical motion. Obviously, stages can be made more massive to dampen vertical vibration. However, this approach increases the inertia of the stage, making rapid movement and braking more challenging and energy-consuming.

In U.S. Pat. No. 6,184,596 to Ohzeki discloses a stage construction that includes a fixed stage and a magnetically levitated movable stage which is driven in mutually perpendicular X, Y, and Z axis directions with respect to the fixed stage by magnetic action between itself and the fixed stage. The fixed stage includes a magnet and a closed plenum in which the magnet is sealed. The movable stage includes a magnetic material which is opposed to the magnet and which experiences an attractive or repulsive magnetic force with respect to the magnet to effect levitation and smooth stage motion.

An object of the invention was to devise a stage that could be moved rapidly, i.e., having low inertia, could be manufactured inexpensively, yet has superior damping of vertical motion, retaining flatness of the stage during and after translation.

### SUMMARY OF INVENTION

The above object has been met by magnetically loading a light weight, low inertia stage, such as an aluminum plate stage, with force in the vertical direction or z-direction that pulls and maintains the movable stage towards the fixed stage, holding stage members together, as well as dampening vertical motion. The stage features a sandwich construction that is held together by powerful magnets. In the past, magnetism associated with a precision stage has been mostly eschewed because electron beam devices, such as electron microscopes, might have their beams influenced by an external magnetic field, an effect that would not be acceptable. In the present invention one or more magnets below the stage have a flux-blocking shield member surrounding most of the magnet to effectively prevent flux from extending upwardly in a direction where an electron beam might be located. Downwardly extending flux lines couple to a ferromagnetic strip across a thin air gap in the fixed stage to pull the movable stage downwardly or in the z-direction. This has the desired effect of dampening vibration on the movable stage in the x-y plane by exerting attractive force between the plates during motion. One or more magnets with ferromagnetic shields above and an opposed ferromagnetic strip below may be mounted in linear grooves within stage plates thereby forming the force element by a simple manufacturing technique.

Since there is force drawing the fixed and movable stages together, bearings defining the spacing between the stages may be loosely placed in races formed by parallel, thin steel rods held in spaced apart grooves. The bearings roll between and upon the rods with little surface contact or deformation except at the point of tangency between the bearing and the rod. The grooves are machined into the fixed stage for ease of manufacture, yet the bearings are held in place between the stages by the magnetic force exerted between stages. This is a further simple and low cost manufacturing technique that provides improved performance in precision equipment stages.

### BRIEF DESCRIPTION OF THE DRAWINGS

FIG. 1 is a front perspective view of a stage with a manual stage driver.

FIG. 2 is a front perspective view of a stage with magnetic loading in accordance with the invention.

FIG. 3 is a top view of a stage of FIG. 2.

FIG. 4 is a side sectional view of the stage shown in FIG. 3 taken along lines 3-3.

FIG. 5 is an exploded detail of the circle 4 shown in FIG. 4.

### DESCRIPTION OF INVENTION

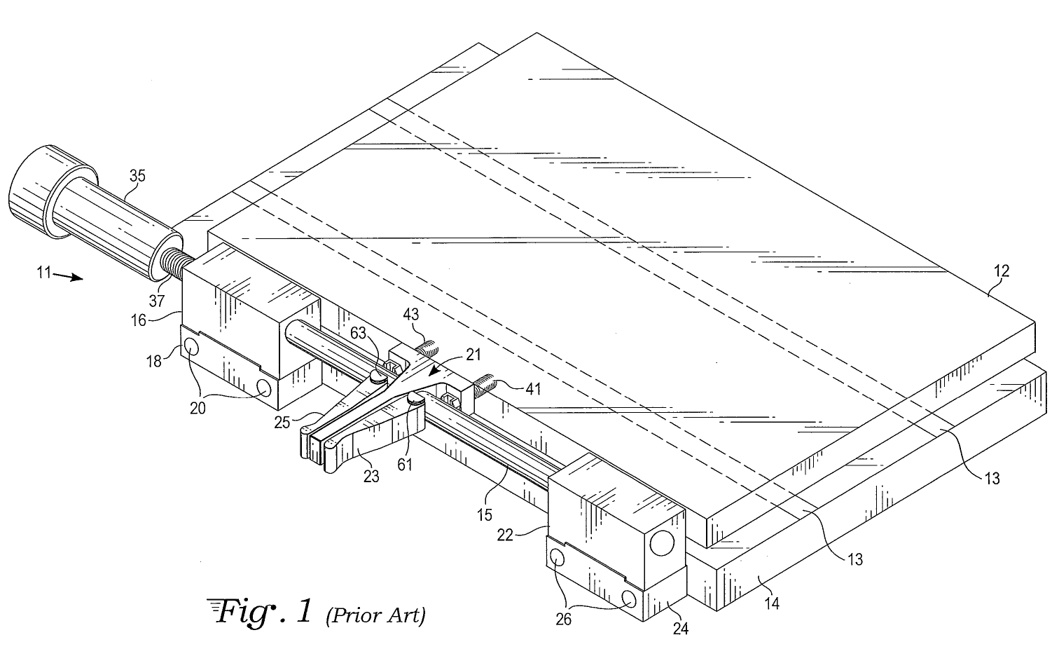

With reference to FIG. 1, a stage 11 is shown having a stage driver of the type shown in prior is application Ser. No. 12/789,035. The stage driver has a portion attached to movable stage 12 and another portion attached to fixed stage 14. Rails 13 are associated with fixed stage 14 allowing free motion of movable stage 12 on the rails. Rails 13 can be arranged in multiple ways. The stage 12 slides back and forth over the fixed stage 14 on the rails in x-direction motion. The stages are typically flat and made of stable, durable material such as solid metal plates. Aluminum has suitable properties because it has low mass and is non-magnetic.

Stage driver 11 has a shaft 15 that is aligned parallel to the direction of motion of the movable stage 12. The shaft 15 is supported by spaced-apart blocks 16, 18 and 22, 24. One of the chief purposes of the shaft is to support yoke 21 which has a T-shape with a bore that allows sliding on shaft 15. Shaft 15 is shown as round, a preferred shape, but may be square or polygonal in cross-section so long as the yoke slides on the shaft. Screws 41 and 43 anchor the yoke 21 to the movable stage 12. Alongside the yoke body are a first pivot member 23 and a symmetrically disposed second pivot member 25. The pivot members are hand holdable members that pivot in opposite directions. The yoke may be controlled by fingers of a user who pinches the first and second pivot members together allowing free sliding of the yoke on the shaft. When fingers are released from the pivot members, the pivot members have inward ends which make contact with shaft 15 locking the yoke in place as will be explained below. The shaft is supported at opposite ends by support blocks including a first lower support block 18 which is fixed to the fixed stage 14 by means of fasteners 20. A first upper support block 16 has an axial bore allowing shaft 15 to be seated therein by means of a threaded connection using threads 37 controlled by knob 35. In other words, the shaft screws into the first upper support block providing a very fine position control of the shaft with regard to the fixed stage. The first upper support block 16 is connected to the first lower support block 18 by means of fasteners not shown. The fasteners allow slight adjustment of the position of the upper support block with respect to the lower support block.

Opposite the support blocks 16 and 18 is the second upper support block 22 which is connected to second lower support block 24 at the distal end of shaft 15. The second lower support block 24 is connected to the fixed stage 14 by means of fasteners 26 in the same manner that the first lower support block 18 is connected to the fixed stage 14 by means of the fasteners 20. The second upper support block 22 has an axial bore allowing the shaft to be supported therein. No threads are present and shaft 15 merely slides into the second upper support block 22 and can move slightly by force of the previously mentioned screw.

Other stage drivers may be used such as linear electromechanical actuators or air actuators or purely mechanical devices. The stage driver is not part of the present invention but is shown and described to illustrate stage motion in general.

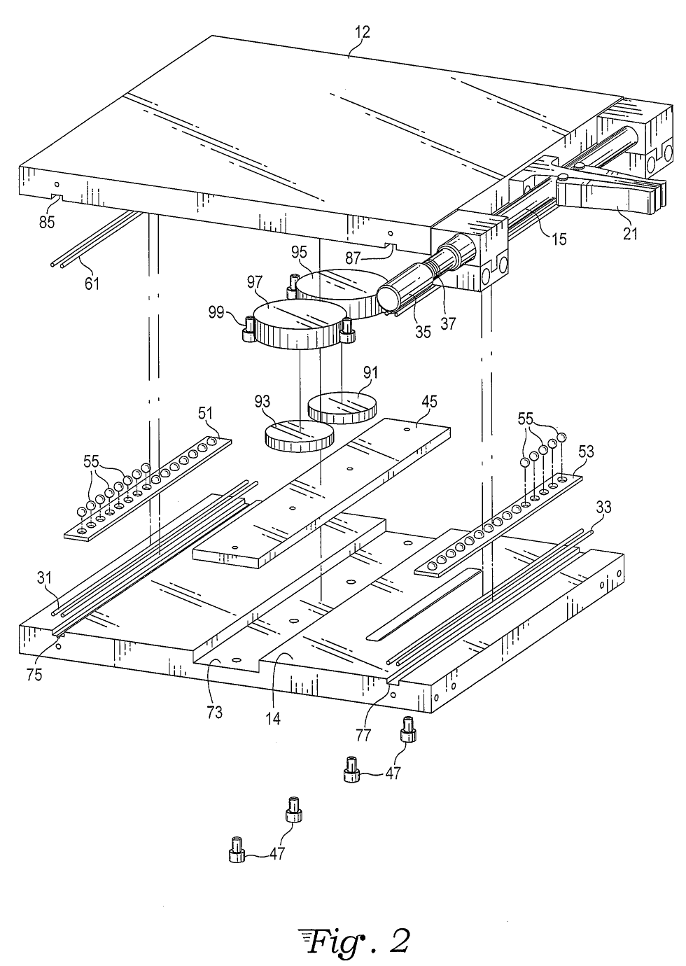

With reference to FIG. 2, a movable stage plate 12, preferably made of aluminum, is disposed above a fixed stage plate 14, also preferably aluminum. Aluminum plates are light weight and therefore have low inertia, making them very responsive to acceleration forces. The movable plate 12 will move in a single direction, say x direction, relative to the fixed plate when force is applied in that direction. For x-y motion, it would be possible to treat movable stage plate 12 as a fixed plate relative to another movable plate, not shown, atop the plate 12. For simplicity, this upper plate giving rise to x-y motion is not shown or discussed, although commonly needed and used. Motion of a single movable plate can illustrate the present invention. As previously discussed, coarse motion of the movable plate 12 is achieved by a hand operated yoke 21 moving along guide shaft 15. Fine motion is achieved by means of knob 35 turning on threads 37. Mounting blocks 16 and 22 connect the upper and lower plates in a manner such that motion of upper plate 12 is guided on guide bar or shaft 15 by yoke 21. The guide shaft 15 establishes a direction of motion for the movable stage plate.

The two stage plates are separated by a few thousandths of an inch and therefore the plate surfaces do not contact each other. The main force holding the plates together is a magnetic structure described below. The fixed plate 14 has three lengthwise parallel channels that are important for guiding the motion of the movable stage plate 12 relative to the fixed stage 14 similar to rails. The first lengthwise channel 73 is a groove that runs in the x direction at the center of the fixed stage plate 14. The groove has a sufficient depth to accommodate a high permeability of ferromagnetic bar 45 which will become magnetized or is already magnetic material. The second and third lengthwise channels 75 and 77, respectively, are much narrower lengthwise grooves parallel to the first lengthwise groove 73. The channels or grooves 75 and 77 are sufficiently wide to seat pairs of parallel rods 31 and 33 which will, in turn, seat ball bearings in a tangent relation with the rods. The rods can be held in place by grease so that the rods can be pushed apart by the ball bearings when downward pressure is applied so that the bearings carrying channels or grooves are rail members. In operation, the ball bearings contact the rods and roll over them while maintaining a tangent relation. The balls 55 are held in first and second ball bearing cages 51 and 53, respectively. The ball bearing cage 51 seats a row of bearings 55 in a generally equal spaced relation. Third and fourth parallel rods exist in the lengthwise channels or grooves in the movable storage plate 12. For example, third parallel rods 61 may be seen in the fourth lengthwise channel or groove 85 in the movable plate 12. A fifth lengthwise channel 87 is a groove above the third lengthwise channel or groove 77 for seating another pair of parallel rods and ball bearings in the second bearing cage 53. The fourth and fifth channels or grooves are rail members for the stage. The second and fourth channels form one rail while the third and fifth channels form another rail. Strong disk-shaped magnets, such as magnets 91 and 93 are seated in the high permeability ferromagnetic shields 95 and 97 within the upper stage plate. Each shield preferably surrounds a corresponding disk-shaped magnet 91 except on an open side facing the magnetic bar 45. Shield retaining screws 99 connect the shields to the movable plate 12. Although shown as cup-shaped, the shields could be trough shaped.

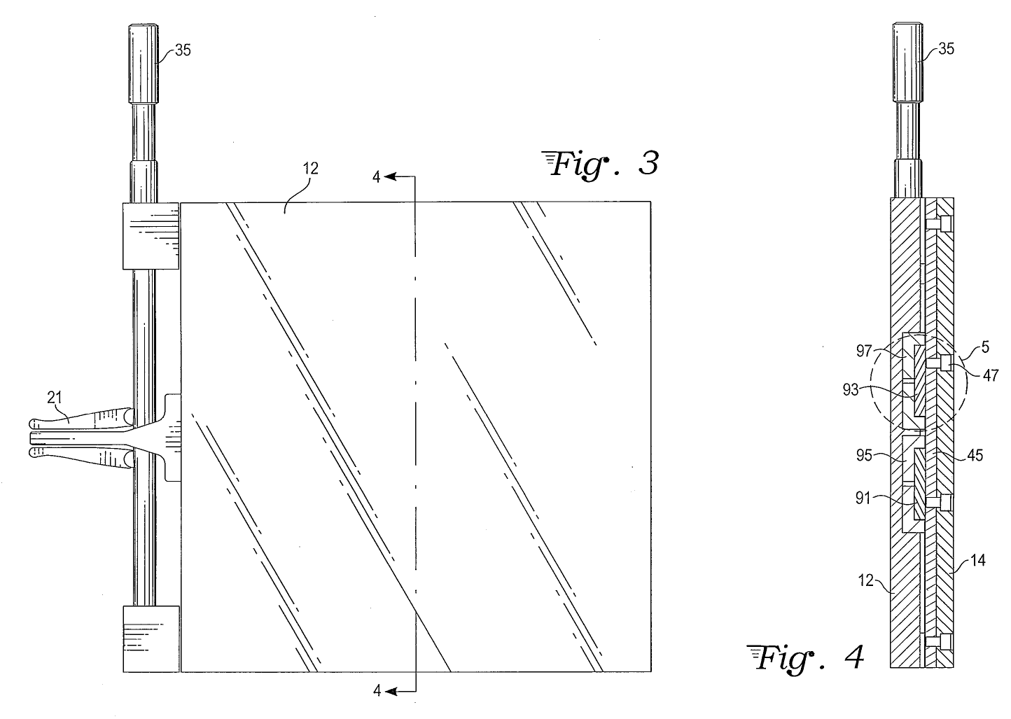

In FIG. 3, the movable stage plate 12 is seen to be controlled by the driver that is yoke 21 for coarse motion and the fine motion controller which is seen to be the knob 35 for screw adjustment of shaft 15.

In FIG. 4, the shields 95 and 97 are seen to nest the disk-shaped magnets 91 and 93. The lengthwise high permeability ferromagnetic bar 45 is slightly spaced from the disk-magnets 91 and 93 by a few thousandths of an inch. The ferromagnetic bar 45 is held in place against the fixed stage plate 14 by means of screws 47. The disk magnets have sufficient field strength relative to bar 45 to hold the movable plate in close proximity to the fixed plate.

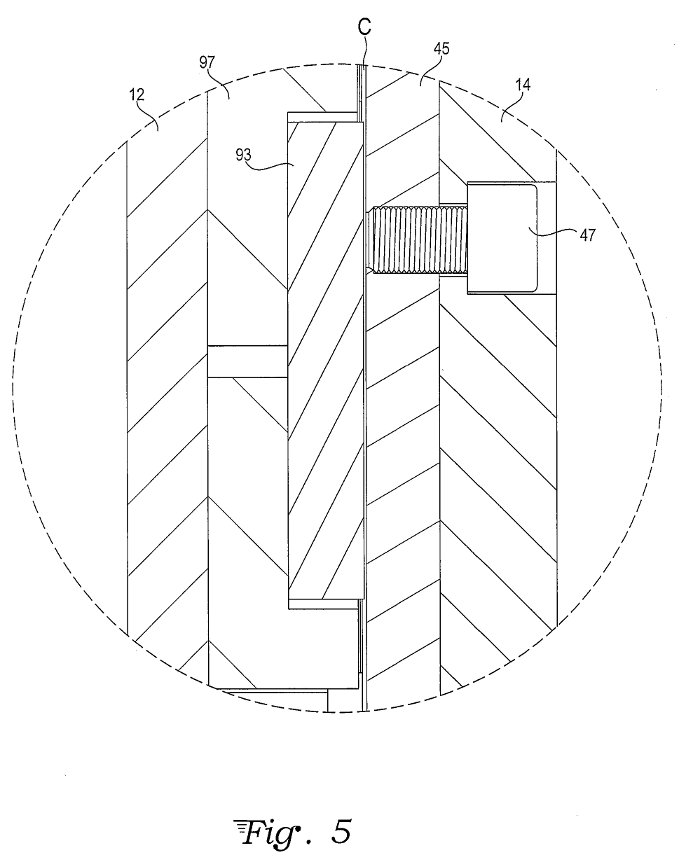

In the detail of FIG. 5, the upper plate 12 is seen to be immediately above the second shield member 97 which surrounds the second disk magnet 93 having a clearance C of a few thousandths of an inch relative to the lengthwise high permeability ferromagnetic bar 45. The ferromagnetic bar is connected to fixed stage plate 14 by means of screw 47. The fixed stage plate is preferably made of non-magnetic material, such as aluminum, so that magnetic flux lines are mostly confined to the ferromagnetic bar, the magnets, and the space between them.

It is not necessary that the strong disk magnets 91 and 93 have a disk shape. The magnets could be replaced by a lengthwise bar, although the resultant in magnetic field lines could be more noticeable on the upper surface of a non-magnetic movable stage. The circularly nesting shield members, such as shield 97 provide circular symmetry for shunting magnetic flux lines and preventing most flux from appearing on the upper surface of movable stage 12. The shield members could have other shapes such as trough shaped or even a bar shape. The five parallel channels in the two plates are easy to machine in aluminum plates and allow inexpensive construction of a movable stage. The stage plates could be made of other material besides aluminum but non-magnetic material is preferred. The strong magnets held against the underside of the movable stage plate 12 will keep the stage plates together as well as reducing vibration and vertical motion of the movable to stage plate 12. It is very difficult to pull the plates apart by hand once the movable stage is placed on the fixed stage with grooves aligned and magnets over the ferromagnetic bar.

What is claimed is:

1. A planar work supporting stage comprising,
a fixed plate having spaced apart parallel rail members and having a channel therebetween with a ferromagnetic bar therein;
a movable plate having parallel spaced apart rail members engaging the rail members of the fixed plate in a sliding relationship and having magnets placed over said ferromagnetic bar in the channel; and
a guide shaft parallel to the rail members and adjacently communicating linear motion to the movable plate relative to the fixed plate.

2. The apparatus of claim 1 wherein the fixed and movable plates are aluminum.

3. The apparatus of claim 1 wherein the magnets are disk shaped.

4. The apparatus of claim 3 wherein the disk shaped magnets are adjacent to ferromagnetic shield members that are open to said ferromagnetic bar.

5. The apparatus of claim 1 wherein the rail members are grooves in the fixed and movable plates.

6. The apparatus of claim 1 wherein the fixed and movable plates are horizontally disposed.

7. A method of assembling movable stages comprising:
making spaced apart, facing parallel grooves in fixed and movable plates of a stage with bearings in the grooves so that the plates slide relative to each other on rails formed by the groves and bearings;
making a channel seating a ferromagnetic bar in the fixed plate, the channel parallel to the grooves; and
affixing magnets to the movable plate over the channel having sufficient field strength to hold the movable plate in proximity to the fixed plate.

8. The method of claim 7 further defined by providing a guide shaft parallel to the grooves communicating motion to the movable plate over the fixed plate.

9. The method of claim 7 further defined by placing the magnets adjacent to ferromagnetic shields open to the ferromagnetic bar.

10. The method of claim 7 further defined by providing non-magnetic material for the plates.

11. A planar work supporting stage comprising:
a first movable plate disposed over a fixed plate, the two plates having pairs of facing spaced apart parallel channels, each pair of facing channels forming a race capturing ball bearings rolling therein that guide the motion for the movable plate relative to the fixed plate;
a strip of ferromagnetic material embedded in one of the plates parallel to and between the channels; and
a magnet fixedly mounted in the other of the plates closely mounted over the ferromagnetic strip with clearance, the magnet attracted to the strip of ferromagnetic material thereby loading the plates with force acting toward each other.

12. The apparatus of claim 11 wherein the magnet resides in a ferromagnetic trough oriented to block most flux from penetrating said other plate wherein said magnet is mounted.

13. The apparatus of claim 11 wherein the strip of ferromagnetic material is midway between the parallel channels.

14. The apparatus of claim 11 wherein a pair of thin linear rods mount the ball bearings in spaced apart positions, each thin linear rod fitting between facing channels.

15. The apparatus of claim 12 wherein the magnet comprises at least one magnetic disk.

16. The apparatus of claim 15 wherein the ferromagnetic trough is cup-shaped to an extent surrounding the disk.
